(19) United States
(12) Patent Application Publication
(10) Pub. No.: US 2009/0183645 A1
(43) Pub. Date: Jul. 23, 2009

(54) Stamping Device

(75) Inventors: Yusuke Yonetsu, Tokyo (JP); Shuichi Soeda, Tokyo (JP); Amane Suzuki, Tokyo (JP)

Correspondence Address: The Marbury Law Group, PLLC, 11800 Sunrise Valley Drive, Suite 1000, Reston, VA, 20191, US

(73) Assignee: Plus Stationery Corporation, Tokyo (JP)

(21) Appl. No.: 12/350,536

(22) Filed: Jan. 8, 2009

(30) Foreign Application Priority Data
Jan. 18, 2008 (JP) 2008-009285
Mar. 18, 2008 (JP) 2008-069603
Dec. 5, 2008 (JP) 2008-311132

(51) Int. Cl. B41K 1/42

(52) U.S. Cl. 101/333

(57) ABSTRACT

An object of the invention is to provide a stamping device which can easily conceal personal information written or printed by stamping a pattern on a portion where the personal information is written or printed. According to the invention, there is provided a stamping device comprising a rectangular stamping block whose lower surface is made to function as a stamping surface, an ink absorbed mat which is impregnated with an ink and is superimposed on an upper surface of the stamping block, and a stamp main body having the stamping block and the ink absorbed mat, the stamping surface being pressed against a pattern transfer target object to thereby transfer a pattern of the stamping surface on to the pattern transfer target object, wherein the stamping surface comprises a pattern configuration which is formed by densely arranging characters, figures or pictures, or straight lines and curved lines to thereby have spaces of small areas defined therebetween, whereby by stamping the pattern configured in the way described above on characters written or printed on a sheet of paper, the characters so written or printed can be concealed, thereby making it possible to realize the protection of personal information.

### CROSS-REFERENCE TO RELATED APPLICATION

This application is based upon and claims the benefit of priority from the prior Japanese Patent Application No. 2008-009285 filed on Jan. 18, 2008, No. 2008-069603 filed on Mar. 18, 2008 and No. 2008-311132 filed on Dec. 5, 2008 the entire contents of which are incorporated herein by reference.

### BACKGROUND OF THE INVENTION

1. Field of the Invention

The present invention relates to a stamping device including a self-inking rubber stamp for making it difficult to read personal information written or printed on a sheet of paper.

2. Background Art

Currently, there are provided stamping devices including self-inking rubber stamps as stamps enabling continuous stamping. Such stamping devices are stamps which have a porous rubber printing or stamping block which absorbs and holds ink therein for continuous stamping using no ink pad every time stamping is performed. These stamping devices including self-inking rubber stamps have been getting inevitable both in household and business scenes, and there have been made many proposals in relation to the stamping devices including self-inking rubber stamps.

For example, Japanese Unexamined Patent Publication No. 2005-96154 proposes a self-inking rubber stamp in which a porous stamping block, which is a porous rubber stamping block, is press fitted in an inner circumference of a frame or short cylindrical body to be fixed in place therein by making use of the elasticity held by the porous stamping block, whereby an uniform, deep and clear impression of a raised printing or stamping surface can be obtained.

### SUMMARY OF THE INVENTION

In recent years, much attention has been paid to protection of personal information in association with legislation of the personal information protection act, and in business, the protection of personal information has become a critical issue. Generally, sheets of paper on which personal information is written or printed are disposed of by shredding them for protection of the personal information. However, when there occurs a need to make a copy of other information than the personal information on the paper, a portion of the paper where the personal information is printed is covered with a correction tape or painted black with a pen or the like before making a copy of needed information. Thus, some labor hours are necessary to complete the copy.

The present invention has been made with a view to eliminating the labor hours, and an object thereof is to provide a stamping device for stamping a pattern on a portion of a sheet of paper or the like where personal information is written or printed for easy concealment of the personal information so written or printed.

According to a preferred aspect of the invention, there is provided a stamping device comprising a stamping block one surface of which is made to function as a printing or stamping surface, the stamping surface being pressed against a pattern transfer target object so as to transfer a designed pattern on the stamping surface on to the pattern transfer target object, wherein the stamping surface comprises a pattern configuration formed by densely arranging characters, figures or pictures, or straight lines and curved lines in such a manner as to reduce areas of spaces defined between the characters, the figures or pictures, or the straight lines and the curved lines.

In the invention, the stamping surface may comprise a pattern configuration having spaces formed in an irregular fashion.

In addition, in the invention, the stamping surface may comprise a pattern configuration formed by the use of lines of various thicknesses.

Further, in the invention, the stamping surface may comprise a pattern configuration formed by arranging characters of various sizes in an irregularly scattering fashion so as to fill the spaces.

Furthermore, in the invention, the stamping surface may comprise a pattern configuration formed by filling characters in figures.

In addition, in the invention, the stamping device may be a self-inking rubber stamp type stamping device comprising the stamping block which is rectangular and whose lower surface is made to function as a stamping surface, an ink absorbed mat which is impregnated with ink and is superimposed on the stamping block, and a stamp main body which holds the stamping block and the ink absorbed mat, wherein a designed pattern given to the stamping surface is transferred on to a pattern transfer target object by the stamping surface being pressed against the pattern transfer target object.

Further, in the invention, the stamping device may be a transfer type stamping device comprising the stamping block which is rectangular and one surface of which is made to function as a stamping surface, and an ink pad for inking the stamping surface of the stamping block, wherein a designed pattern given to the stamping surface is transferred on to a pattern transfer target object by the stamping block being rotated so as to be pressed against the pattern transfer target object.

According to the preferred aspect of the invention, with the stamping surface holds the pattern configuration formed by densely arranging figures or pictures, a stamping device can be provided whereby not only can the protection of personal information be achieved but also the working efficiency can be improved.

### BRIEF DESCRIPTION OF THE DRAWINGS

FIG. 1 is a sectional view of a stamping device 1 according to the invention,

FIG. 2 shows reference diagrams in relation to a pattern configuration held on a stamping surface of the stamping device according to the invention, and

FIG. 3 shows reference diagrams in relation to a pattern configuration held on a stamping surface of a stamping device according to another embodiment of the invention. In addition,

FIG. 4 is a sectional view of a further stamping device having a different configuration according to a further embodiment of the invention,

FIG. 5 is a vertical sectional view of a stamping device having a different configuration according to a further embodiment of the invention which results when the stamping device is in a closed state, and

FIG. 6 is a vertical sectional view of the stamping device having the further different configuration according to the further embodiment of the invention which results when the stamping device is in an open state.

### DESCRIPTION OF THE PREFERRED EMBODIMENTS

A stamping device 1 of a preferred embodiment of the invention includes a rectangular rubber stamping block 7 a predetermined surface of which is made to function as a printing or stamping surface 7a, an ink absorbed mat 8 which is superimposed on a rear surface of the stamping surface 7a of the rubber stamping block 7 and which is impregnated with an ink and a stamp main body 2 which has the rubber stamping block 7 and the ink absorbed mat 8. In addition, this stamping device 1 is such that the stamping surface 7a is pressed against a pattern transfer target object so as to transfer a pattern held on the stamping surface 7a on to the pattern transfer object.

In addition, the stamping surface 7a holds a pattern configuration in which uppercase and lowercase alphabets of various sizes are arranged in an irregularly scattering fashion so as to fill spaces formed therebetween and irregularly formed spaces are provided between the characters so arranged. Consequently, by the pattern configured in the way described above being stamped on characters written or printed on a sheet of paper or the like by the use of the stamping device 1, characters representing personal information can be concealed by the pattern, thereby making it possible to realize the protection of the personal information.

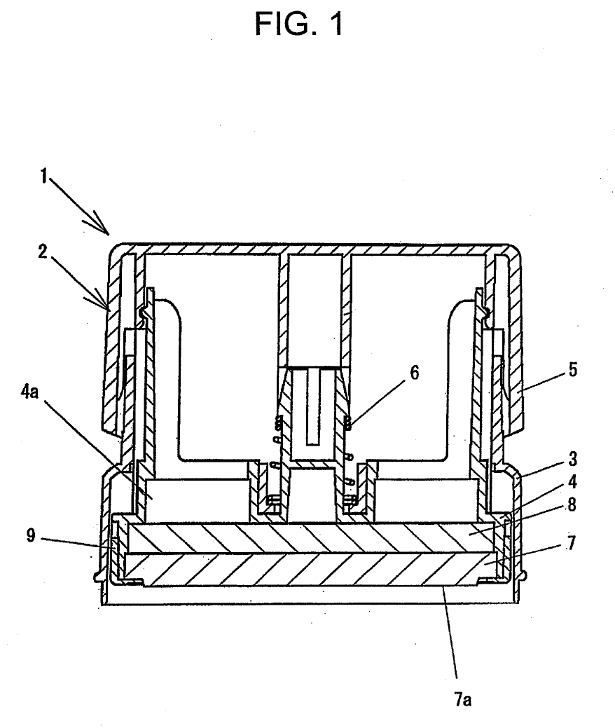

Hereinafter, embodiments of the invention will be described in detail based on the accompanying drawings. As is shown in FIG. 1, a stamping device 1 according to an embodiment of the invention includes a rectangular rubber stamping block 7 a predetermined surface (a lower surface) of which is made to function as a stamping surface 7a, an ink absorbed mat 8 which is superimposed on a rear surface (an upper surface) of the stamping surface 7a of the rubber stamping block 7 and which is impregnated with an ink and a stamp main body 2 which has the rubber stamping block 7 and the ink absorbed mat 8. This stamp main body 2 is made up of a sheath element 3, a printing part holding member 4 and a handle member 5. The printing part holding member 4 is movably accommodated in the sheath element 3 and holds the ink absorbed mat 8 and the rubber stamping block 7 in the vicinity of a lower end thereof. In addition, the handle member 5 is disposed above the sheath element 3 for pushing the printing part holding member 4 downwards. Then, in this stamping device 1, when the handle member 5 is pushed down in such a state that a lower end of the sheath element 3 is left in contact with a pattern transfer target object, the printing part holding member 4 is pushed downwards by the handle member 5, and the printing part holding member 4 descends in an interior of the sheath element 3, whereby the stamping surface 7a is brought into contact with the pattern transfer target object, and the pattern held on the stamping surface 7a is transferred on to the pattern transfer target object.

In addition, the stamp main body 2 includes an elastic element 6 which is disposed between the sheath element 3 and the printing part holding member 4. This elastic element 6 biases the printing part holding member 4 upwards in the interior of the sheath element 3. Consequently, in such a state that no external force is exerted on the handle member 5, the printing part holding member 4 is accommodated in the interior of the sheath element 3 by virtue of the elastic force of the elastic element 6. Further, the printing part holding member 4 includes an ink supply hole 4a, and by an ink being injected from this ink supply hole 4a, the ink can be supplied into the ink absorbed mat 8.

The rubber stamping block 7 is a rectangular plate formed of a porous rubber material having continuous pores. In addition, this rubber stamping block 7 includes a predetermined pattern forming projection on a lower surface thereof, and the pattern held on the stamping surface 7a is made up of the pattern forming projection. Furthermore, the rubber stamping block 7 is disposed in the vicinity of the lower end of the printing part holding member 4 and is held in the vicinity of an outer circumferential edge of the stamping surface 7a by a stamping surface holding frame 9. In such a state that the stamping block 7 is so held, the pattern forming projection of the rubber stamping block 7 projects slightly downwards from the lower end of the printing part holding member 4.

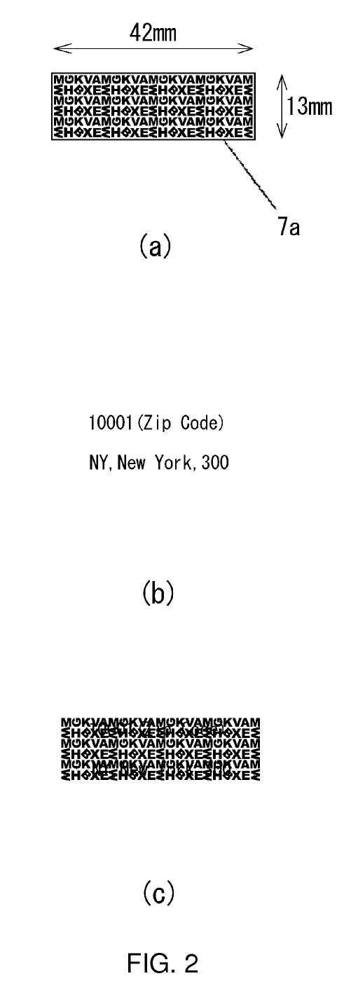

In addition, the stamping surface 7a of the rubber stamping block 7 is formed by the pattern forming projection into a pattern configuration in which uppercase alphabets of six points are densely arranged vertically and horizontally at equal intervals as is shown in FIG. 2A within a rectangular area which is 42 mm long and 13 mm wide. In addition, the uppercase alphabets are arranged in a state in which the alphabets are inclined at a predetermined angle or in a state in which they are not inclined (a state in which center lines of the alphabets are parallel to a vertical center line of the rubber stamping block 7). In addition, in general, one point is 1/72 in. in height and width, and assuming that one inch (in) is 25 mm, one point is 0.35 mm in height and width. Thus, the height and width of the alphabets making up the stamping surface become 2.1 mm.

In addition, since the pattern on the stamping surface 7a is made into the configuration in which the uppercase alphabets of six points, which is small in point size, are densely arranged or compacted, small spaces are defined between the characters. Note that while the alphabets of six points are used in this embodiment, the invention is not limited thereto.

The ink absorbed mat 8 is a rectangular plate which is formed from a thermoplastic resin which is harder than the rubber stamping block 7 and which has a high permeability. In addition, the ink absorbed mat 8 is penetrated with ink and supplies the ink to the rubber stamping block 7 in conjunction with the utilization of the stamping device 1. The ink absorbed mat 8 also functions as a substrate which presses against the rubber stamping block 7, which is softer, by a flat plane thereof when the pattern is stamped on the pattern transfer target object.

In addition, when the pattern on the stamping surface 7a is transferred onto the pattern transfer target object by the stamping device 1 stamping the pattern on a portion on the pattern transfer target object where personal information such as a zip code and address is written or printed as is shown in FIG. 2B, what is written or printed on the portion to which the pattern on the stamping surface 7a is transferred is concealed, as is shown in FIG. 2C, by the pattern so transferred, whereby the personal information written or printed can be made impossible or difficult to read.

In addition, in the stamping device 1 of the embodiment, since the pattern configuration is realized in which the uppercase alphabets of six points are densely arranged vertically and horizontally at equal intervals, as is shown in FIG. 2A, the spaces of small areas defined between the respective alphabets can be maintained small, and hence, relatively small characters of 18 points or smaller, that is, 6.3 mm or smaller can be made difficult to read.

Consequently, personal information can be concealed only by stamping the pattern on the portion on the pattern transfer target object where the personal information is written or printed without concealing the personal information on the pattern transfer target object with a correction tape, a pen or the like as has been done conventionally, whereby not only can the protection of the personal information be realized but also the working efficiency can be improved.

Although it is considered to make the stamping surface 7a flat so that the ink is applied to the whole area of the stamping surface 7a to paint out totally the characters which make up personal information, as this occurs, when the stamping surface 7a is pressed against a sheet of paper or the like, since the stamping surface 7a is made difficult to be deformed, there is caused a problem that a uniform transfer cannot be attained. In addition, there is also caused a problem that the ink is repelled at portions of a pattern transfer target object where characters are printed, whereby characters to be concealed appear conspicuous. To cope with these problems, in this embodiment, the portions where the ink is repelled are decreased by defining the spaces of small areas, so that the characters to be concealed are made difficult to be seen.

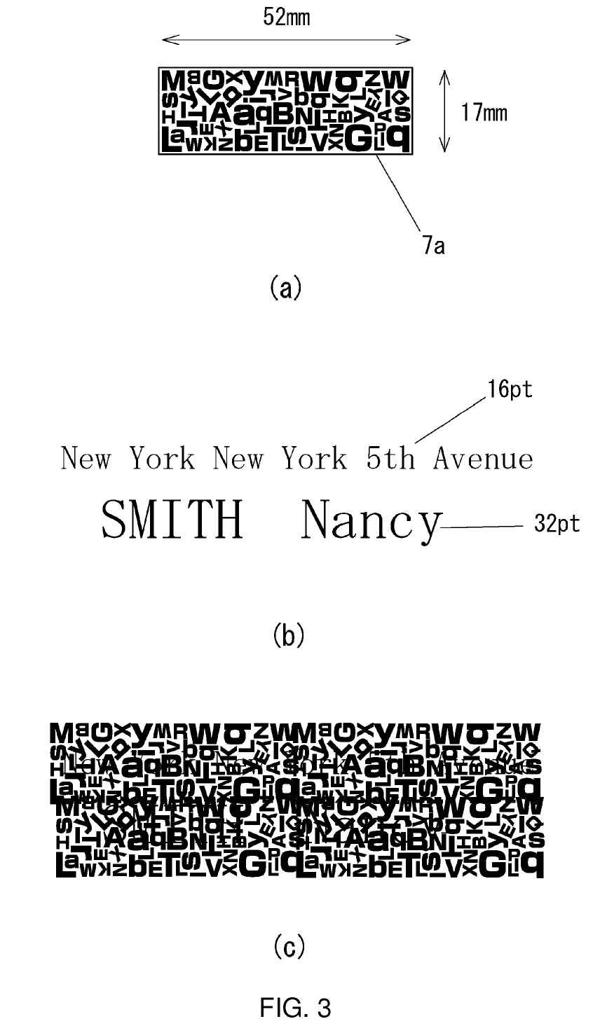

Next, another embodiment of the invention will be described. A stamping surface 7a of a rubber stamping block 7 of a stamping device 1 according to this embodiment is given by a pattern forming projection a pattern configuration in which uppercase alphabets and lowercase alphabets of various point sizes are densely arranged or compacted within an area which is 52 mm long and 17 mm wide, as is shown in FIG. 3A. In addition, the uppercase alphabets and lowercase alphabets of various point sizes are disposed on the stamping surface 7a in such a state that they are inclined at a predetermined angle or in such a state that they are not inclined. Note that the other features as to the pattern configuration formed on the stamping surface 7a are made identical to those of the stamping device 1 of the previous embodiment.

The pattern configuration on the stamping surface 7a is such that large and small alphabets of 10 points (3.5 mm in height and width) to 22 points (7.7 mm in height and width) are dispersed irregularly in such a manner as to fill spaces that are defined therebetween. Consequently, by the alphabets of various sizes being dispersed irregularly, the pattern configuration on the stamping surface 7a is made to include irregular spaces. Note that while the alphabets of point sizes which range from 10 points to 22 points are used, the invention is not limited thereto.

In the stamping device 1 of the embodiment, the pattern configured on the stamping surface 7a in the way described above is stamped to be transferred on to a portion on a pattern transfer target object where personal information as is shown in FIG. 3B is written or printed, since the pattern so transferred conceals the personal information as is shown in FIG. 3C, the personal information so concealed can be made difficult to read.

In addition, by forming the irregular spaces by disposing the uppercase and lowercase alphabets of large and small various sizes in an irregularly scattering fashion, even though characters making up personal information that is wanted to be concealed happen to be situated in the space portions, since characters before and after the specific characters now situated in the space portions never fail to be concealed by the pattern, the personal information cannot be read, thereby making it possible to enhance the concealing effect of the personal information.

In addition, since lines forming the alphabets of large point sizes become thick by forming the stamping surface 7a by the use of the alphabets of large and small various point sizes, even characters of 16 points (5.6 mm in height and width) and larger characters of 32 points (11 mm in height and width) which are shown in FIG. 3B can be concealed. Thus, characters of relatively large point sizes can be concealed compared with the case where only the alphabets of 6 points are used as has been described in the previous embodiment. In addition, by the use of the stamping device 1 of this embodiment, relatively large characters of 36 points (13 mm in height and width) or smaller can be concealed or made impossible to read. Consequently, since characters of large point sizes which are used to print addresses on post cards personal information can be concealed, personal information can easily be concealed in the way described in the previous embodiment, thereby making it possible to realize an improvement in working efficiency.

Note that in the embodiments described heretofore, while alphabets are used to form the pattern configurations, since characters can be concealed when a pattern configuration having spaces of small areas is given to the stamping surface 7a, the same advantage can be obtained even when characters other than alphabets are used which include numerals, Kanji characters, Russian characters, Arabic characters and the like. In addition, by forming a pattern configuration having irregular spaces which are defined by lines of various thickness, characters from small to large characters can be concealed.

In addition, the pattern configuration formed on the stamping surface 7a is not limited to those in which characters are densely arranged or compacted, and hence, it is possible to use a pattern configuration in which diamond shapes, pictures or figures of flowers or the like are densely arranged, a pattern configuration in which straight and wavy lines of various thicknesses are made to intersect so as to decrease the areas of space portions defined therebetween, and the like. In addition, a pattern configuration can also be formed by combining QR codes with characters or by embedding characters in pictures or figures. Furthermore, the external shape of the stamping device 1 is not limited to that described in the embodiments, and hence, the invention can also be applied to other stamping devices of various types. In addition, although the rectangular rubber stamping block 7 is used, the shape of the rubber stamping block 7 is not limited thereto.

Furthermore, while the stamping device 1 described above is the self-inking rubber stamp type stamping device, the stamping device 1 may take the form of a stamping device of type in which a stamping surface of a rubber stamping block is inked by the stamping surface being brought into abutment with an ink pad. Hereinafter, stamping devices according to other embodiments of the invention will be described in which a stamping surface of a rubber stamping block is brought into abutment with an ink pad for inking.

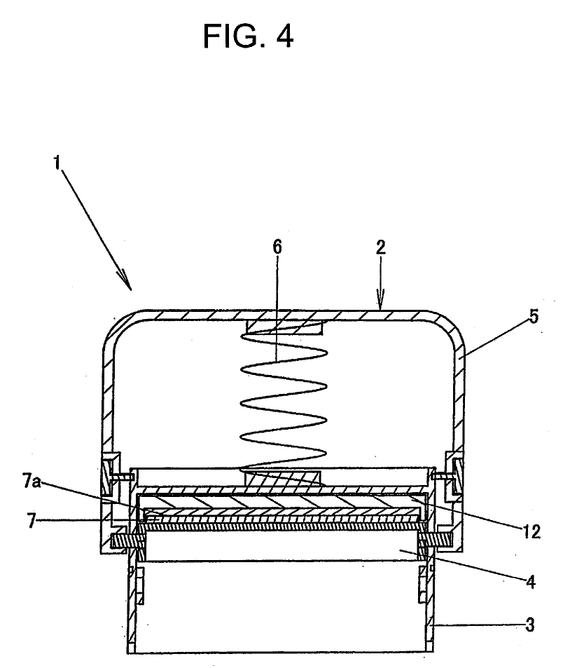

FIG. 4 is a sectional view of a rotary stamping device 1 according to another embodiment of the invention which has an external shape which is different from the aforesaid embodiment. This stamping device 1 is made up of a stamping part holding member 4 including a rubber stamping block 7, a replaceable ink pad 12, and a stamp main body 2. In addition, the stamp main body 2 is made up of a sheath element 3 which accommodates the printing part holding member 4 rotatably and a handle member 5.

This printing part holding member 4 is accommodated in an interior of the sheath element 3 in such a manner as to rotate and slide therein and is also attached pivotally inside the handle member 5 via the sheath element 3. In addition, the sheath element 3 is disposed inside the handle member 5 in such a state that the sheath element 3 is biased downwards by an elastic element 6. Thus, in this stamping device 1, when the handle member 5 is pushed downwards, the handle member 5 moves downwards relative to the sheath element 3, and the printing part holding member 4 also rotates a half of one full rotation (rotates through 180 degrees), whereby the stamping surface 7a is oriented downwards, causing the sheath element 3 to slide downwards to enable stamping. On the contrary, when the handle member 5 so pushed downwards is then released, the handle member 5 is biased upwards by the elastic element 6 to rise, and the printing part holding member 4 is also returned to its original position. In addition, in this stamping device, with the printing part holding member 4 restored to its original position, the stamping surface 7a of the rubber stamping block 7 is in abutment with the ink pad 12.

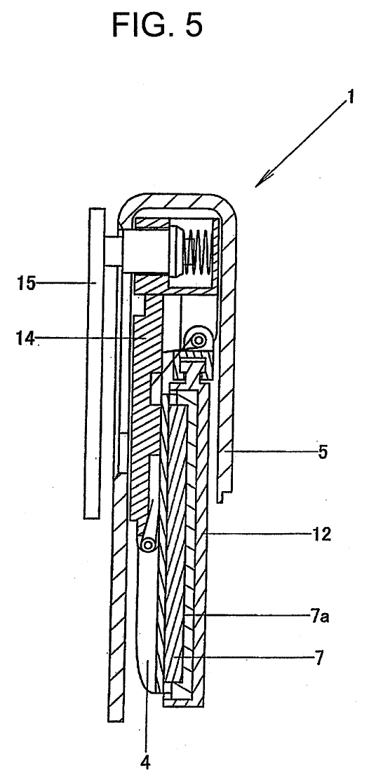

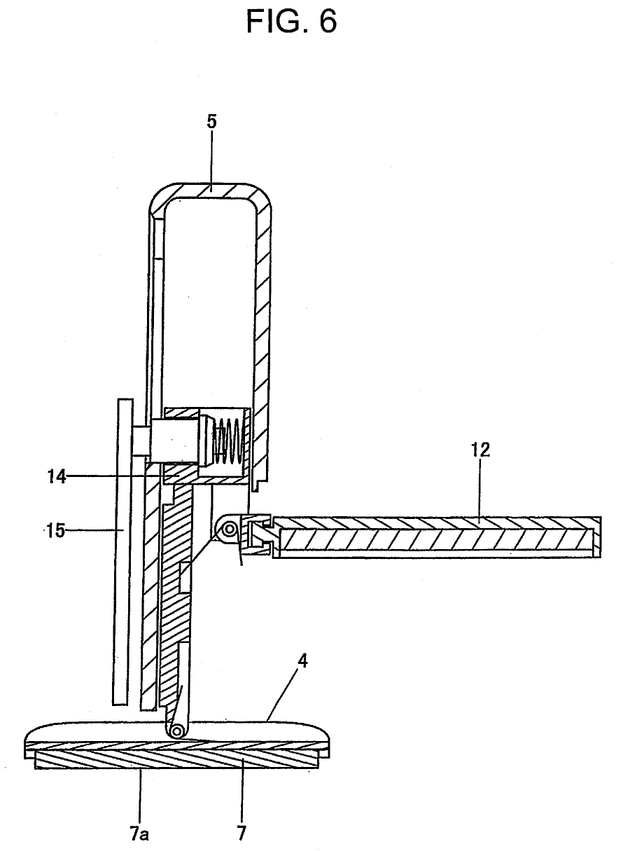

Further, the following configuration can be adopted as a stamping device 1 of a further different type which utilizes an ink pad. FIG. 5 is a vertical sectional view of a stamping device 1 having a further different configuration according to a further embodiment of the invention which results when the stamping device is in a closed state and FIG. 6 is a vertical sectional view of the stamping device 1 which results when the stamping device is in an open state. As is shown in FIG. 5, this stamping device 1 is used for stamping when it is deployed from the closed state in which a rubber stamping block 7 is accommodated to an open state shown in FIG. 6.

In addition, this stamping device 1 is made up of a printing part holding member 4 which includes a rubber stamping block 7, a replaceable ink pad 12, a handle member 5, a sliding member 14, and a control member 15. As is shown in FIG. 5, in the stamping device 1, the printing part holding member 4 and the ink pad 12 are accommodated within the handle member 5 in such a state that the printing part holding member 4 and the ink pad 12 are pivotally attached to the sliding member 14. In this stamping device 1 that is configured as described above, when the control member 15, which is connected to the sliding member 14, is caused to slide downwards, as is shown in FIG. 6, the printing part holding member 4 and the ink pad 12 project from the handle member 5 and rotate (through 90 degrees) to enable stamping. In addition, in this stamping device 1, when it is in the closed state, the stamping surface 7a of the stamping block 7 is in abutment with the ink pad 12.

Note that the invention is not limited to the stamping devices which are configured as described in the embodiments that have been described heretofore but can be modified variously to be applied to various types of stamping devices.

What is claimed is:

1. A stamping device comprising a stamping block one surface of which is made to function as a printing or stamping surface, the stamping surface being pressed against a pattern transfer target object so as to transfer a designed pattern on the stamping surface on to the pattern transfer target object, wherein the stamping surface comprises a pattern configuration formed by densely arranging characters, figures or pictures, or straight lines and curved lines in such a manner as to reduce areas of spaces defined between the characters, the figures or pictures, or the straight lines and the curved lines.

2. A stamping device as set forth in claim 1, wherein the stamping surface comprises a pattern configuration having spaces formed in an irregular fashion.

3. A stamping device as set forth in claim 1, wherein the stamping surface comprises a pattern configuration formed by the use of lines of various thicknesses.

4. A stamping device as set forth in claim 2, wherein the stamping surface comprises a pattern configuration formed by the use of lines of various thicknesses.

5. A stamping device as set forth in claim 1, wherein the stamping surface comprises a pattern configuration formed by arranging characters of various sizes in an irregularly scattering fashion so as to fill the spaces.

6. A stamping device as set forth in claim 2, wherein the stamping surface comprises a pattern configuration formed by arranging characters of various sizes in an irregularly scattering fashion so as to fill the spaces.

7. A stamping device as set forth in claim 3, wherein the stamping surface comprises a pattern configuration formed by arranging characters of various sizes in an irregularly scattering fashion so as to fill the spaces.

8. A stamping device as set forth in claim 4, wherein the stamping surface comprises a pattern configuration formed by arranging characters of various sizes in an irregularly scattering fashion so as to fill the spaces.

9. A stamping device as set forth in claim 1, wherein the stamping surface comprises a pattern configuration formed by filling characters in figures.

10. A stamping device as set forth in claim 2, wherein the stamping surface comprises a pattern configuration formed by filling characters in figures.

11. A stamping device as set forth in claim 3, wherein the stamping surface comprises a pattern configuration formed by filling characters in figures.

12. A stamping device as set forth in claim 4, wherein the stamping surface comprises a pattern configuration formed by filling characters in figures.

13. A stamping device as set forth in claim 1, wherein the stamping device is a self-inking rubber stamp type stamping device comprising the stamping block which is rectangular and whose lower surface is made to function as a stamping surface, an ink absorbed mat which is impregnated with ink and is superimposed on the stamping block, and a stamp main body which has the stamping block and the ink absorbed mat, wherein a designed pattern given to the stamping surface is transferred on to a pattern transfer target object by the stamping surface being pressed against the pattern transfer target object.

14. A stamping device as set forth in claim 2, wherein the stamping device is a self-inking rubber stamp type stamping device comprising the stamping block which is rectangular and whose lower surface is made to function as a stamping surface, an ink absorbed mat which is impregnated with ink and is superimposed on the stamping block, and a stamp main body which has the stamping block and the ink absorbed mat, wherein a designed pattern given to the stamping surface is transferred on to a pattern transfer target object by the stamping surface being pressed against the pattern transfer target object.

15. A stamping device as set forth in claim 4, wherein the stamping device is a self-inking rubber stamp type stamping device comprising the stamping block which is rectangular and whose lower surface is made to function as a stamping surface, an ink absorbed mat which is impregnated with ink and is superimposed on the stamping block, and a stamp main body which has the stamping block and the ink absorbed mat, wherein a designed pattern given to the stamping surface is transferred on to a pattern transfer target object by the stamping surface being pressed against the pattern transfer target object.

16. A stamping device as set forth in claim 6, wherein the stamping device is a self-inking rubber stamp type stamping device comprising the stamping block which is rectangular and whose lower surface is made to function as a stamping surface, an ink absorbed mat which is impregnated with ink and is superimposed on the stamping block, and a stamp main body which has the stamping block and the ink absorbed mat, wherein a designed pattern given to the stamping surface is transferred on to a pattern transfer target object by the stamping surface being pressed against the pattern transfer target object.

17. A stamping device as set forth in claim 8, wherein the stamping device is a self-inking rubber stamp type stamping device comprising the stamping block which is rectangular and whose lower surface is made to function as a stamping surface, an ink absorbed mat which is impregnated with ink and is superimposed on the stamping block, and a stamp main body which has the stamping block and the ink absorbed mat, wherein a designed pattern given to the stamping surface is transferred on to a pattern transfer target object by the stamping surface being pressed against the pattern transfer target object.

18. A stamping device as set forth in claim 1, wherein the stamping device is a transfer type stamping device comprising the stamping block which is rectangular and one surface of which is made to function as a stamping surface, and an ink pad for inking the stamping surface of the stamping block, wherein a designed pattern given to the stamping surface is transferred on to a pattern transfer target object by the stamping block being rotated so as to be pressed against the pattern transfer target object.

19. A stamping device as set forth in claim 2, wherein the stamping device is a transfer type stamping device comprising the stamping block which is rectangular and one surface of which is made to function as a stamping surface, and an ink pad for inking the stamping surface of the stamping block, wherein a designed pattern given to the stamping surface is transferred on to a pattern transfer target object by the stamping block being rotated so as to be pressed against the pattern transfer target object.

20. A stamping device as set forth in claim 4, wherein the stamping device is a transfer type stamping device comprising the stamping block which is rectangular and one surface of which is made to function as a stamping surface, and an ink pad for inking the stamping surface of the stamping block, wherein a designed pattern given to the stamping surface is transferred on to a pattern transfer target object by the stamping block being rotated so as to be pressed against the pattern transfer target object.

21. A stamping device as set forth in claim 6, wherein the stamping device is a transfer type stamping device comprising the stamping block which is rectangular and one surface of which is made to function as a stamping surface, and an ink pad for inking the stamping surface of the stamping block, wherein a designed pattern given to the stamping surface is transferred on to a pattern transfer target object by the stamping block being rotated so as to be pressed against the pattern transfer target object.

22. A stamping device as set forth in claim 8, wherein the stamping device is a transfer type stamping device comprising the stamping block which is rectangular and one surface of which is made to function as a stamping surface, and an ink pad for inking the stamping surface of the stamping block, wherein a designed pattern given to the stamping surface is transferred on to a pattern transfer target object by the stamping block being rotated so as to be pressed against the pattern transfer target object.
